(19) United States
(12) Patent Application Publication
(10) Pub. No.: US 2026/0177792 A1
(43) Pub. Date: Jun. 25, 2026

(54) PROJECTION LENS

(71) Applicant: Young Optics Inc., Hsinchu Science Park (TW)

(72) Inventors: SHUO-CHIEH CHANG, Hsinchu Science Park (TW); KUO-CHUAN WANG, Hsinchu Science Park (TW)

(21) Appl. No.: 19/424,756

(22) Filed: Dec. 18, 2025

(30) Foreign Application Priority Data
Dec. 20, 2024 (TW) 113150044

(51) Int. Cl. G02B 13/16; G03B 21/14; G03B 21/20

(52) U.S. Cl. CPC G02B 13/16; G03B 21/142; G03B 21/2033

(57) ABSTRACT

A projection lens includes a first lens group, an aperture stop and a second lens group arranged in order from a magnified side to a minified side. The projection lens satisfies the following conditions: (1) 0.2<BFL/EFL<0.6, where EFL is an effective focal length of the projection lens, and BFL is a back focal length of the projection lens; and (2) an axial distance between any pair of lenses in the projection lens remains constant during operation.

### BACKGROUND OF THE INVENTION

### a. Field of the Invention

The invention relates to a projection lens.

### b. Description of the Related Art

In recent years, demands for and applications of projection lenses have become increasingly diverse. One of the demands is how to utilize a relatively large aperture in particular environments, such as indoor or in-vehicle environments, to satisfy requirements on depth of field and resolution for the projection lens. Such a design involves considerable difficulty and is one of the problems to be solved by the invention.

For example, when the projection lens is applied to a vehicle, since the vehicle often encounters bumps and vibrations, faces extreme temperatures (high temperatures or low temperatures), and is exposed to dusty or humid environments when driving outdoors, this is different from application scenarios of traditional general projection devices which are typically stationary and subject to a small range of temperature variations. In addition, a balance between optical quality and cost also needs to be considered.

### BRIEF SUMMARY OF THE INVENTION

According to one aspect of the present disclosure, a projection lens includes a first lens group, an aperture stop and a second lens group arranged in order from a magnified side to a minified side of the projection lens. The first lens group consists essentially of four or five lenses, and the four or five lenses include an aspheric lens disposed at a position corresponding to a first or second lens as counted from the magnified side toward the minified side. The second lens group consists essentially of five or six lenses, the five or six lenses include a cemented doublet and an aspheric lens, and the aspheric lens of the second lens group is located at a position closest to the minified side. A total number of aspheric lenses in the projection lens is less than or equal to 3, and the projection lens satisfies the following conditions: (1) 0.2<BFL/EFL<0.6, where EFL is an effective focal length of the projection lens, and BFL is a back focal length of the projection lens; and (2) an axial distance between any pair of lenses in the projection lens remains constant during operation. If the value of BFL/EFL is smaller than the lower limit, aberrations may be difficult to control or a depth of field may be insufficient; conversely, if the value of BFL/EFL is greater than the upper limit, a volume of the optical system or a full field of view (FOV) may become excessively large.

According to another aspect of the present disclosure, a projection lens includes a first lens group, an aperture stop and a second lens group arranged in order from a magnified side to a minified side of the projection lens. The first lens group consists essentially of four or five lenses, and a first lens or a second lens as counted from the magnified side toward the minified side is a molded glass aspheric lens. The second lens group consists essentially of five or six lenses, and the five or six lenses include a cemented doublet and a molded glass aspheric lens disposed at a position closest to the minified side. The projection lens satisfies the following conditions: (1) 0.02<BFL/D<0.06, where BFL is a back focal length of the projection lens, and D is a distance measured on an optical axis of the projection lens between a lens surface of the projection lens closest to the magnified side and a lens surface of the projection lens closest to the minified side; (2) an axial distance between any pair of lenses in the projection lens remains constant during operation; and (3) a total number of aspheric lenses in the projection lens is less than or equal to 3. If the value of BFL/D is smaller than the lower limit, aberrations may be difficult to control; conversely, if the value BFL/D is greater than the upper limit, a volume of the optical system may become excessively large.

According to another aspect of the present disclosure, a projection lens includes a first lens group, an aperture stop and a second lens group arranged in order from a magnified side to a minified side of the projection lens. The first lens group consists essentially of four or five lenses, and the four or five lenses include a first aspheric lens disposed at a position corresponding to a first or second lens as counted from the magnified side toward the minified side. The second lens group consists essentially of five or six lenses, the five or six lenses include a cemented doublet and a second aspheric lens, and the second aspheric lens of the second lens group is located at a position closest to the minified side. A total number of aspheric lenses in the projection lens is less than or equal to 3, and the projection lens satisfies the following conditions: (1) a depth of field range is defined by EFL/D, where EFL is an effective focal length of the projection lens, and D is a distance measured on an optical axis of the projection lens between a lens surface of the projection lens closest to the magnified side and a lens surface of the projection lens closest to the minified side, and the depth of field range is in a range between 0.075 and 0.19; and (2) an axial distance between any pair of lenses in the projection lens remains constant during operation.

In one embodiment, the projection lens satisfies a condition of 0.2<BFL/EFL<0.5.

In one embodiment, the projection lens satisfies a condition of 0.02<BFL/D<0.05.

In one embodiment, the depth of field range of the projection lens is in a range between 0.075 and 0.095.

Based on the design of various embodiments of the invention, by appropriately configuring glass or plastic lenses with spherical and aspheric lenses, manufacturing costs can be reduced while maintaining image quality, and a reduced number of lenses is achieved. Thereby, a projection lens suitable for no focus adjustment within a certain projection range in vehicles is provided, that is, where a distance between a lens surface of the projection lens closest to the minified side and a light-emitting surface of a self-luminous light valve is kept constant. The projection lens may further offer at least one of the following advantages: shock resistance, a wide operating temperature range, dust and water resistance, high resolution, a large aperture, a large field of view, high reliability, and lower manufacturing costs while maintaining good imaging quality.

Other objectives, features and advantages of the invention will be further understood from the further technological features disclosed by the embodiments of the invention wherein there are shown and described preferred embodiments of this invention, simply by way of illustration of modes best suited to carry out the invention.

### BRIEF DESCRIPTION OF THE DRAWINGS

FIG. 1 is a schematic diagram illustrating an optical structure of a projection lens according to a first embodiment of the invention.

FIG. 2 is a schematic diagram illustrating an optical structure of a projection lens according to a second embodiment of the invention.

FIG. 3 is a schematic diagram illustrating an optical structure of a projection lens according to a third embodiment of the invention.

FIG. 4 is a schematic diagram illustrating an optical structure of a projection lens according to a fourth embodiment of the invention.

FIG. 5 is a schematic diagram illustrating an optical structure of a projection lens according to a fifth embodiment of the invention.

FIG. 6 is a schematic diagram illustrating an optical structure of a projection lens according to a sixth embodiment of the invention.

FIG. 7 is a schematic diagram illustrating an optical structure of a projection lens according to a seventh embodiment of the invention.

FIG. 8 is a schematic diagram illustrating an optical structure of a projection lens according to an eighth embodiment of the invention.

FIG. 9 is a schematic diagram illustrating an optical structure of a projection lens according to a ninth embodiment of the invention.

FIG. 10 and FIG. 11 show MTF curves of the projection lens 10a at a short projection distance and a long projection distance, respectively.

FIG. 12 and FIG. 13 show MTF curves of the projection lens 10c at a short projection distance and a long projection distance, respectively.

FIG. 14 and FIG. 15 show MTF curves of the projection lens 10f at a short projection distance and a long projection distance, respectively.

### DETAILED DESCRIPTION OF THE INVENTION

In the following detailed description of the preferred embodiments, directional terminology, such as “top,” “bottom,” “front,” “back,” etc., is used with reference to the orientation of the Figure(s) being described. The components of the invention can be positioned in a number of different orientations. As such, the directional terminology is used for purposes of illustration and is in no way limiting. Further, “First,” “Second,” etc., as used herein, are used as labels for nouns that they precede, and do not imply any type of ordering (e.g., spatial, temporal, logical, etc.).

To achieve environmental adaptability of the vehicle projection lens, embodiments of the invention may set one or more of the following specific technical requirements and standards. The following are some typical numerical examples of these conditions, which may vary depending on different manufacturers and application requirements: (1) Thermal shock resistance: the vehicle projection lens should be capable of normal operation within a range of −40° C. to +85° C. (or wider). (2) Humidity variation: the lens is typically required to operate for several hours or days under conditions of up to 95% non-condensing humidity to simulate a humid environment. (3) Vibration tolerance: the lens should be proven through testing to be capable of operation under specific vibration conditions.

The term “lens” in the invention refers to an element made of a partially or fully transmissive material and having refractive power, and typically comprises glass or plastic.

When the lens is applied in a projection system, the magnified side of the lens refers to a side located closer to an imaging surface (for example, a screen) in an optical path, and the minified side refers to a side located closer to a light source or a light valve in the optical path.

A certain region of an object side surface (or an image side surface) of a lens may be convex or concave. Herein, a convex or concave region is more outwardly protruded or inwardly recessed in a direction parallel to an optical axis relative to an outer region radially adjacent to the region.

In the following embodiments of the invention, at a spatial frequency of 40 line pairs per millimeter (lp/mm), when modulation transfer function (MTF) values at two ends of a projection distance range are 40%, one end corresponds to a short projection distance and the other end corresponds to a long projection distance, which are typically obtained without focus adjustment. A ratio of EFL to the short projection distance is in a range between 0.008 and 0.19, and a ratio of EFL to the long projection distance is in a range between 0.004 and 0.005. In the following embodiments of the invention, a chief ray angle (CRA) of the projection lens is less than 8.5 degrees, where the chief ray angle is defined as an angle between a chief ray incident on an image plane of the projection lens and a normal to the image plane.

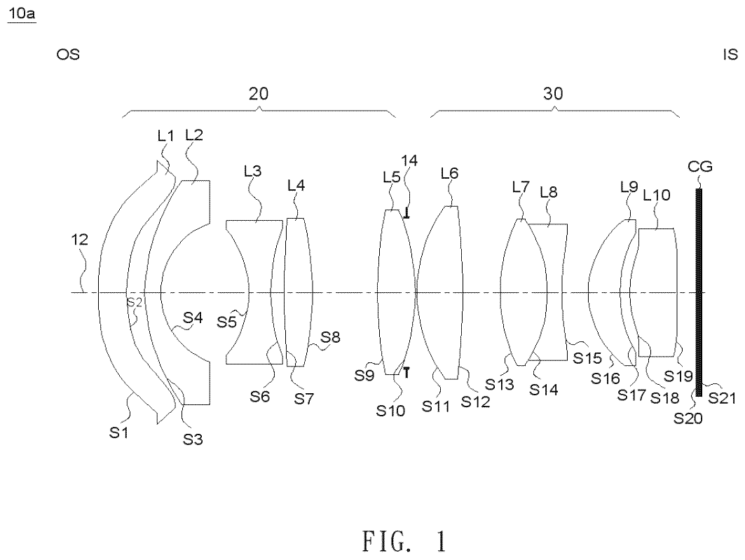

FIG. 1 is a schematic diagram illustrating an optical structure of a projection lens according to a first embodiment of the invention. Referring to FIG. 1, in this embodiment, the projection lens 10a is disposed between a magnified side OS and a minified side IS. The projection lens 10a has a lens barrel (not shown). A first lens group 20, an aperture stop 14 and a second lens group 30 are arranged in order from the magnified side OS to the minified side IS inside the lens barrel. In addition, an image source (light-emitting surface) 16 is located at a position corresponding to the minified side IS. In this embodiment, the projection lens 10a consists essentially of ten lenses, and refractive powers of the lenses L1 to L10 are respectively negative, negative, negative, positive, positive, positive, positive, negative, positive and positive in order along an optical axis 12. The first lens group 20 includes the lenses L1 to L5, and the second lens group 30 includes the lenses L6 to L10. The aspheric lenses L1 and L10 are aspheric glass lenses, and the lenses L2 to L9 are spherical glass lenses. The lens L7 and the lens L8 form a cemented doublet, which can improve chromatic aberration of the projection lens 10a. In one embodiment, the aspheric lens L1 may be an aspheric plastic lens and formed of a material such as PMMA or PC.

In each of the following embodiments, all lenses are not limited to have specific optical characteristic, shape and number and may vary according to actual demands. Besides, in each of the following embodiments, the magnified side OS is located on the left side and the minified side IS is located on the right side of each figure, and thus this is not repeatedly described in the following for brevity.

The aperture stop 14 achieves a similar effect by using a mechanical member to block peripheral light and allow a central portion of light to pass through, wherein the mechanical member is adjustable. The term “adjustable” refers to adjustment of a position, a shape, or transparency of the mechanical member, but the adjustment of the position is limited to fine-tuning between lenses immediately before and after an original design position, as fine-tuning to compensate for manufacturing tolerances. For example, in this embodiment, the aperture stop 14 is disposed after the fifth lens L5 and before the sixth lens L6. The position of the aperture stop 14 can be moved between the fifth lens L5 and the sixth lens L6, but cannot be moved to a position before the fifth lens L5 or a position after the sixth lens L6. This is because such movement of the aperture stop 14 would degrade image quality of the projection lens 10a, and the entire projection lens would need to be redesigned to obtain good projection image quality. In some embodiments, the aperture stop 14 may not be an independent optical element, but an inner diameter of the lens barrel serves as the aperture stop 14. Alternatively, the aperture stop 14 may be formed by coating an opaque light-absorbing material on a lens surface and leaving a central portion transparent to achieve an effect of limiting an optical path. When the aperture of the aperture stop 14 is larger, the projection lens corresponds to a smaller F-number. In at least some embodiments of the invention, the F-number of the projection lens is in a range between 0.9 and 1.2. In one embodiment, the F-number of the projection lens is in a range between 0.95 and 1.15. In another embodiment, the F-number of the projection lens is in a range between 1.0 and 1.1. In the following embodiments of the invention, a ratio of the EFL of the projection lens to an absolute value of an effective focal length of an aspheric lens closest to the magnified side is in a range between 0 and 0.4. If the ratio exceeds the upper limit of 0.4, the aspheric lens closest to the magnified side would be too sensitive. In one embodiment, the ratio of the EFL of the projection lens to the absolute value of the effective focal length of the aspheric lens closest to the magnified side is in a range between 0 and 0.2. In another embodiment, the ratio of the EFL of the projection lens to the absolute value of the effective focal length of the aspheric lens closest to the magnified side is in a range between 0.2 and 0.4. In this embodiment, the F-number of the projection lens 10a is 1.05, and the ratio of the EFL of the projection lens to the absolute value of the effective focal length of the aspheric lens closest to the magnified side is 0.0593.

In at least some embodiments of the invention, an effective focal length (EFL) of the projection lens is in a range between 4 mm and 11 mm, a back focal length (BFL) is in a range between 2 mm and 3 mm, and a value of BFL/EFL is in a range between 0.2 and 0.6. If the value of BFL/EFL is smaller than the lower limit, aberrations may be difficult to control or a depth of field may be insufficient; conversely, if the value is greater than the upper limit, a volume of the optical system or the full field of view (FOV) may become excessively large. In one embodiment, the value of BFL/EFL is in a range between 0.2 and 0.5. In another embodiment, the value of BFL/EFL is in a range between 0.4 and 0.55. The back focal length (BFL) is a distance measured along an optical axis 12 from an optical surface closest to the minified side IS (e.g., the surface S19 of the lens L10 in FIG. 1) to the image source 16 (surface S21). A projection distance is the shortest distance from a lens surface of the projection lens closest to the magnified side to a projection surface, and a ratio of EFL to the projection distance is in a range between 0.002 and 0.02. The projection lens is a telecentric lens, and a telecentric angle of the projection lens is smaller than 3 degrees. The projection lens includes at most one plastic lens, and remaining lenses are glass lenses, wherein a total number of aspheric lenses in the projection lens is less than or equal to 3. Furthermore, in at least some embodiments of the invention, a length D of the projection lens along the optical axis between two outermost lens surfaces (e.g., the lens surfaces S1 and S19 in FIG. 1) is in a range between 50 mm and 67 mm, and a total track length (TTL) of the projection lens is less than or equal to 75 mm. The total track length TTL is a distance measured along the optical axis 12 from an optical surface closest to the magnified side OS (e.g., the surface S1 of the first lens L1 in FIG. 1) to the image source 16 (surface S21). In one embodiment, a value of D/EFL is in a range between 10 and 14. In another embodiment, the value of D/EFL is in a range between 10.5 and 13.5. In this embodiment, the effective focal length EFL of the projection lens 10a is 4.92 mm, BFL is 2.63 mm, the value of BFL/EFL is 0.5346, D is 62.37 mm, and TTL is 65 mm. A ratio of EFL to the short projection distance is 0.008663, and a ratio of EFL to the long projection distance is 0.004577. In one embodiment, a value of BFL/D is in a range between 0.02 and 0.06. If the value of BFL/D is smaller than the lower limit, aberrations may be difficult to control; conversely, if the value BFL/D is greater than the upper limit, a volume of the optical system may become excessively large. In another embodiment, the value of BFL/D is in a range between 0.02 and 0.05. In still another embodiment, the value of BFL/D is in a range between 0.023 and 0.048. In this embodiment, the value of BFL/D of the projection lens 10a is 0.0422.

The full field of view (FOV) refers to a light collection angle of the optical surface S1 closest to the magnified side OS, that is, a field of view measured diagonally. In at least some embodiments of the invention, the full field of view may be in a range between 90 degrees and 100 degrees. In this embodiment, the full field of view (FOV) of the projection lens 10a is 94.3 degrees, and an image height (IMH) of the image source (light-emitting surface) 16 is 5.1 mm.

Detailed optical data and design parameters of the projection lens 10a are shown in Table 1 below. Note the data provided below are not used for limiting the invention, and those skilled in the art may suitably modify parameters or settings of the following embodiment with reference of the invention without departing from the scope or spirit of the invention.

TABLE 1

| | | Radius | Interval | Refractive | Abbe number |
|---|---|---|---|---|---|
| Object description | Surface | (mm) | (mm) | index (Nd) | (Vd) |
| L1(aspheric) | S1* | 103.04 | 3 | 1.60809 | 57.821 |
| | S2* | 33.556 | 1.9392 | | |
| L2(meniscus) | S3 | 21.963 | 1.8 | 1.90043 | 37.372 |
| | S4 | 8.48 | 9.5034 | | |
| L3(bi-concave) | S5 | −11.405 | 2.4008 | 1.531722 | 48.852 |
| | S6 | 22.289 | 1.1521 | | |
| L4(bi-convex) | S7 | 78.78 | 3.3064 | 2.0006 | 25.458 |
| | S8 | −36.269 | 6.9769 | | |
| L5(bi-convex) | S9 | 53.367 | 4.0418 | 1.496997 | 81.608 |
| | S10 | −26.839 | −1.1854 | | |
| aperture stop | | INF | 1.4944 | | |
| L6(bi-convex) | S11 | 17.997 | 4.8138 | 1.62041 | 60.339 |
| | S12 | −86.848 | 4.1112 | | |
| L7(bi-convex) | S13 | 21.753 | 5.1225 | 1.48749 | 70.441 |
| L8(bi-concave) | S14 | −15.178 | 1.5411 | 1.945945 | 17.984 |
| | S15 | 38.006 | 2.7519 | | |
| L9(meniscus) | S16 | 10.667 | 3.5738 | 1.788 | 47.492 |
| | S17 | 15.35 | 1.0264 | | |
| L10(aspheric) | S18* | 12.153 | 5 | 1.7421 | 49.246 |
| | S19* | −500 | 2.1296 | | |
| cover glass | S20 | INF | 0.5 | 1.523014 | 58.588 |
| light-emitting | S21 | INF | 0 | | |
| surface | | | | | |

Table 1 lists the values of parameters for each lens of an optical system, where the surface symbol denoted by an asterisk (*) is an aspheric surface, and a surface without the denotation of an asterisk is a spherical surface.

In Table 1 above, the column labeled “interval (mm)” indicates the straight-line distance between two adjacent surfaces along the optical axis 12. For example, the interval of the surface S1 is the distance between the surface S1 and the surface S2, and the interval of the surface S2 is the distance between the surface S2 and the surface S3. For each lens and each optical element, the thickness, refractive index, and Abbe number correspond to the values listed in the same row under the interval, refractive index, and Abbe number columns, respectively. Parameter values such as the radii of curvature and the intervals of the respective surfaces are given in Table 1 and will not be described again herein.

The radius of curvature is the reciprocal of curvature. When a lens surface has a positive radius of curvature, a center of curvature of the lens surface is located on a side of the lens facing the minified side. When a lens surface has a negative radius of curvature, the center of curvature of the lens surface is located on a side of the lens facing the magnified side, and the convexity or concavity of each lens surface can be seen in Table 1.

An aspheric lens refers to a lens in which at least one of its front or rear surfaces has a radius of curvature that varies with a distance from an optical axis and can be used to correct aberrations. In the following design examples of the invention, each aspheric surface satisfies the following equation:

$$Z = \frac{{cr}^{2}}{1 + \sqrt{1 - ( 1 + k ) {c}^{2} {r}^{2}}} + {Ar}^{4} + {Br}^{6} + {Cr}^{8} + {Dr}^{10} + {Er}^{12} + {Fr}^{14} + {Gr}^{16} + ,$$

where Z denotes a sag of an aspheric surface along the optical axis 12, c denotes a reciprocal of a radius of an osculating sphere, K denotes a Conic constant, r denotes a height of the aspheric surface measured in a direction perpendicular to the optical axis 12, and parameters A-G are 4th, 6th, 8th, 10th, 12th, 14th and 16th order aspheric coefficients. Note the data provided below are not used for limiting the invention, and those skilled in the art may suitably modify parameters or settings of the following embodiment with reference of the invention without departing from the scope or spirit of the invention.

TABLE 2

| | S1* | S2* | S18* | S19* |
|---|---|---|---|---|
| R | 103.04 | 33.56 | 12.15 | −500.00 |
| k | 51.76 | 0.26 | −15.05 | −95.14 |
| A | 3.951718E−04 | 5.236366E−04 | 6.154558E−04 | 2.923224E−04 |
| B | −4.279459E−06 | −6.506131E−06 | −3.802730E−05 | −3.249463E−05 |
| C | 4.440814E−08 | 8.095918E−08 | 1.011899E−06 | 9.217230E−07 |
| D | −3.028362E−10 | −7.010588E−10 | −2.053312E−08 | −1.236220E−08 |
| E | 1.211764E−12 | 2.886303E−12 | 2.690169E−10 | 6.996709E−11 |
| F | −2.222361E−15 | −4.473975E−15 | −1.500265E−12 | 0 |

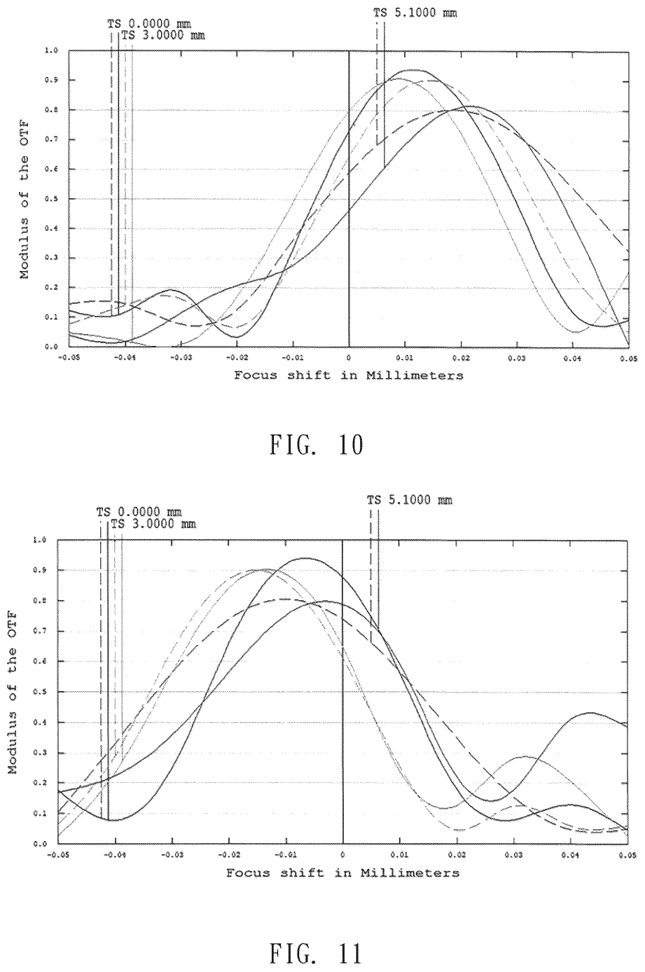

FIG. 10 and FIG. 11 illustrate optical simulation results for the imaging performance of the projection lens 10a. FIG. 10 shows a modulation transfer function (MTF) curve at a short projection distance, and FIG. 11 shows an MTF curve at a long projection distance. A horizontal axis represents focus positions (focus shift in mm), and a vertical axis represents a modulus of an optical transfer function (OTF), that is, an MTF value. Since the curves shown in FIG. 10 and FIG. 11 fall within required ranges, namely that when a spatial frequency is 40 line pairs per millimeter (lp/mm), MTF values within the ranges of the short projection distance and the long projection distance are greater than 40%, this verifies that the projection lens 10a of this embodiment achieves good imaging performance.

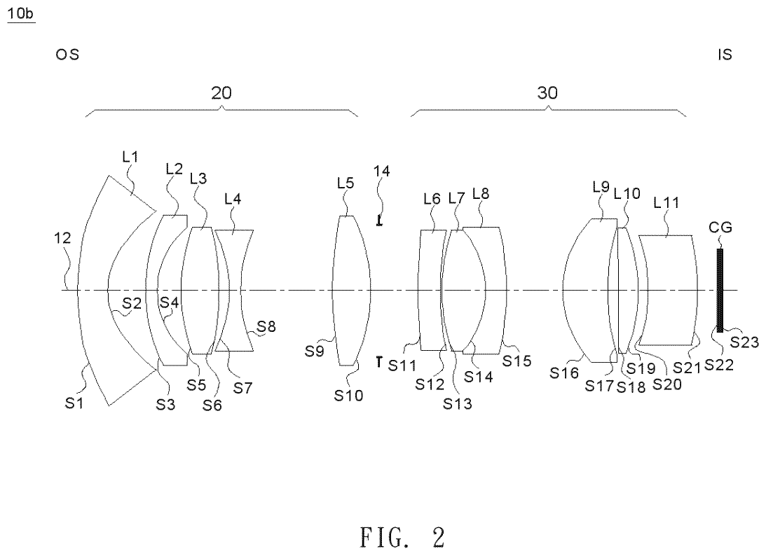

FIG. 2 is a schematic diagram illustrating an optical structure of a projection lens 10b according to a second embodiment of the invention. In this embodiment, the projection lens 10b is disposed between a magnified side OS and a minified side IS. The projection lens 10b includes a first lens group 20, an aperture stop 14, and a second lens group 30 arranged in order from the magnified side OS to the minified side IS. In addition, an image source (light-emitting surface) 16 is located at a position corresponding to the minified side IS. In this embodiment, the projection lens 10b consists essentially of eleven lenses, and refractive powers of the lenses L1 to L11 are respectively negative, negative, positive, negative, positive, negative, positive, negative, positive, positive, and positive in order along an optical axis 12. The first lens group 20 includes the lenses L1 to L5, and the second lens group 30 includes the lenses L6 to L11. The aspheric lenses L1 and L11 are aspheric glass lenses, and the lenses L2 to L10 are spherical glass lenses. The lens L7 and the lens L8 form a cemented doublet, which can improve chromatic aberration of the projection lens 10b. In one embodiment, the aspheric lens L1 may be an aspheric plastic lens formed of a material such as PMMA or PC. The effective focal length EFL is 4.82 mm, the back focal length BFL is 2.28 mm, a value of BFL/EFL is 0.4727, a value of BFL/D is 0.0362, a length D of the projection lens is 62.9 mm, and a total track length TTL is 65.18 mm. A ratio of EFL to the short projection distance is 0.008492, and a ratio of EFL to the long projection distance is 0.004487. In this embodiment, a full field of view (FOV) of the projection lens 10b is 96.2 degrees, an F-number is 1.05, and a ratio of the EFL of the projection lens to an absolute value of an effective focal length of an aspheric lens closest to the magnified side is 0.281. An image height (IMH) of the image source (light-emitting surface) 16 is 5.1 mm.

Detailed optical data and design parameters of the lenses and other optical components of the projection lens 10b are shown in Table 3, and conic constants and aspheric coefficients for each aspheric surface are shown in Table 4.

TABLE 3

| | | | Interval | Refractive | Abbe number |
|---|---|---|---|---|---|
| Object description | Surface | Radius(mm) | (mm) | index (Nd) | (Vd) |
| L1(aspheric) | S1* | 78.041 | 3 | 1.84245 | 40.777 |
| | S2* | 12.014 | 3.8755 | | |
| L2(meniscus) | S3 | 20.584 | 1.1406 | 1.86452 | 38.249 |
| | S4 | 10.166 | 2.4887 | | |
| L3(bi-convex) | S5 | 24.94 | 3.9888 | 1.94394 | 20.069 |
| | S6 | −36.649 | 1.0179 | | |
| L4(bi-concave) | S7 | −16.103 | 1.054 | 1.59831 | 47.249 |
| | S8 | 17.99 | 9.4318 | | |
| L5(bi-convex) | S9 | 53.333 | 3.8285 | 1.86369 | 38.336 |
| | S10 | −21.679 | 1.1682 | | |
| aperture stop | | INF | 3.6457 | | |
| L6(meniscus) | S11 | 103.095 | 2.1724 | 1.94595 | 17.984 |
| | S12 | 41.901 | 0.1 | | |
| L7(bi-convex) | S13 | 26.266 | 4.5375 | 1.63938 | 60.188 |
| L8(meniscus) | S14 | −12.06 | 2.144 | 1.94714 | 18.06 |
| | S15 | −32.345 | 5.7527 | | |
| L9(meniscus) | S16 | 12.898 | 4.4936 | 1.8022 | 46.605 |
| | S17 | 36.132 | 0.9647 | | |
| L10(meniscus) | S18 | −1253.857 | 2.0811 | 1.60617 | 64.488 |
| | S19 | −24.026 | 1.0145 | | |
| L11(aspheric) | S20* | −60.027 | 5 | 1.7541 | 40.455 |
| | S21* | −22.908 | 1.78 | | |
| cover glass | S22 | INF | 0.5 | 1.523014 | 58.588 |
| light-emitting | S23 | INF | 0 | | |
| surface | | | | | |

TABLE 4

| | S1* | S2* | S20* | S21* |
|---|---|---|---|---|
| R | 78.04 | 12.01 | −60.03 | −22.91 |
| k | 29.45 | −0.58 | 68.25 | −99.00 |
| A | 4.472138E−04 | 6.675576E−04 | −4.711237E−04 | 2.971954E−04 |
| B | −7.429746E−06 | −1.114796E−05 | 8.403865E−06 | −1.004185E−05 |
| C | 7.618909E−08 | 1.044565E−07 | −1.451027E−07 | 3.215876E−07 |
| D | −4.836704E−10 | −5.064786E−10 | 1.597850E−09 | −1.327370E−08 |
| E | 1.700874E−12 | 1.166406E−12 | −2.340175E−12 | 1.483942E−10 |
| F | −2.552962E−15 | −1.007047E−15 | −4.531949E−14 | 0 |

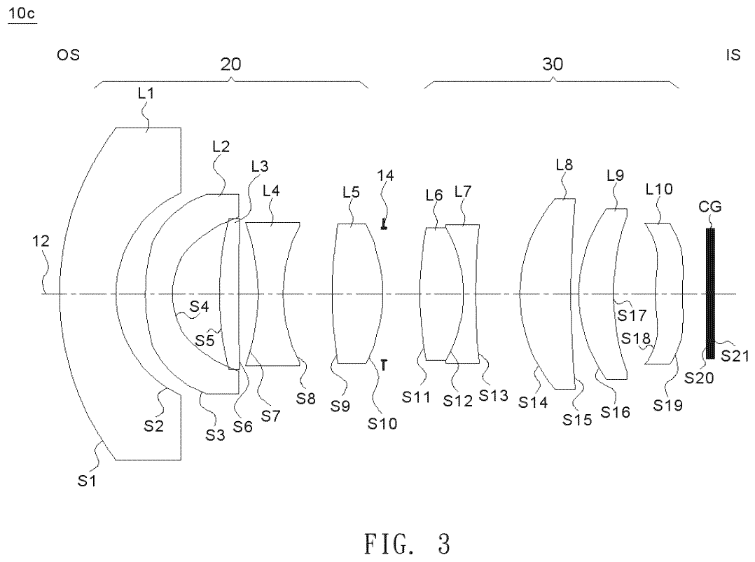

FIG. 3 is a schematic diagram illustrating an optical structure of a projection lens 10c according to a third embodiment of the invention. In this embodiment, the projection lens 10c is disposed between a magnified side OS and a minified side IS. The projection lens 10c includes a first lens group 20, an aperture stop 14, and a second lens group 30 arranged in order from the magnified side OS to the minified side IS. In addition, an image source (light-emitting surface) 16 is located at a position corresponding to the minified side IS. In this embodiment, the projection lens 10c consists essentially of ten lenses, and refractive powers of the lenses L1 to L10 are respectively negative, negative, positive, negative, positive, positive, negative, positive, positive, and positive in order along an optical axis 12. The first lens group 20 includes the lenses L1 to L5, and the second lens group 30 includes the lenses L6 to L10. The aspheric lenses L2, L5, and L10 are aspheric glass lenses, and the remaining lenses L1, L3, L4, and L6 to L9 are spherical glass lenses. The lens L6 and the lens L7 form a cemented doublet, which can improve chromatic aberration of the projection lens 10c. In one embodiment, the aspheric lens L2 may be an aspheric plastic lens formed of a material such as PMMA or PC. In the third embodiment, the effective focal length EFL is 4.99 mm, the back focal length BFL is 2.286 mm, a value of BFL/EFL is 0.4581, a length D of the projection lens is 54.57 mm, a value of BFL/D is 0.0419, and a total track length TTL is 56.85 mm. A ratio of EFL to the short projection distance is 0.008785, and a ratio of EFL to the long projection distance is 0.004642. In this embodiment, a full field of view (FOV) of the projection lens 10c is 96.6 degrees, an F-number is 1.09, and a ratio of the EFL of the projection lens to an absolute value of an effective focal length of an aspheric lens closest to the magnified side is 0.2344. An image height (IMH) of the image source (light-emitting surface) 16 is 5.1 mm. Detailed optical data and design parameters of the lenses and other optical components of the projection lens 10c are shown in Table 5, and conic constants and aspheric coefficients for each aspheric surface are shown in Table 6.

TABLE 5

| | | | Interval | Refractive | Abbe number |
|---|---|---|---|---|---|
| Object description | Surface | Radius(mm) | (mm) | index (Nd) | (Vd) |
| L1(meniscus) | S1 | 23.672 | 5 | 1.50389 | 79.941 |
| | S2 | 9.645 | 2.6142 | | |
| L2(aspheric) | S3* | 42.641 | 2.2868 | 1.50996 | 78.611 |
| | S4* | 8.509 | 4.1608 | | |
| L3(meniscus) | S5 | 29.686 | 1.7104 | 1.94595 | 17.984 |
| | S6 | 471.291 | 1.6479 | | |
| L4(bi-concave) | S7 | −17.564 | 2.1439 | 1.51888 | 76.79 |
| | S8 | 12.266 | 4.4347 | | |
| L5(aspheric) | S9* | 44.614 | 4.338 | 1.77261 | 48.243 |
| | S10* | −15.045 | 0.1 | | |
| aperture stop | | INF | 3.1215 | | |
| L6(bi-convex) | S11 | 30.119 | 3.8999 | 1.7477 | 49.823 |
| L7(bi-concave) | S12 | −11.269 | 1 | 1.91828 | 21.077 |
| | S13 | 82.509 | 3.8965 | | |
| L8(meniscus) | S14 | 13.122 | 4.5104 | 1.65867 | 57.759 |
| | S15 | 120.81 | 0.5969 | | |
| L9(meniscus) | S16 | 13.051 | 3.0042 | 1.80364 | 46.531 |
| | S17 | 21.541 | 3.6909 | | |
| L10(aspheric) | S18* | 14.508 | 2.4085 | 1.84639 | 35.439 |
| | S19* | 30.922 | 1.7862 | | |
| cover glass | S20 | INF | 0.5 | 1.523014 | 58.588 |
| light-emitting | S21 | INF | 0 | | |
| surface | | | | | |

TABLE 6

| | S3* | S4* | S9* | S10* |
|---|---|---|---|---|
| R | 42.64 | 8.51 | 44.61 | −15.04 |
| k | 19.59 | 0.34 | 0.00 | 0.00 |
| A | 9.482454E−04 | 1.159882E−03 | −5.022123E−17 | −2.467795E−05 |
| B | −1.065007E−05 | 1.783095E−06 | 2.274208E−20 | −1.295714E−07 |
| C | 9.711142E−08 | −5.992803E−08 | −1.026839E−21 | 1.587368E−10 |
| D | −8.507516E−10 | −6.194832E−09 | 1.440729E−23 | −5.223692E−14 |
| E | 0 | 0 | 0 | 0 |

| | S18* | S19* |
|---|---|---|
| R | 14.51 | 30.92 |
| k | −28.34 | −1.77 |
| A | −7.092942E−04 | −2.600355E−03 |
| B | −6.785485E−05 | 9.188222E−05 |
| C | 2.107261E−06 | −2.671895E−06 |
| D | −2.132988E−08 | 4.078576E−08 |
| E | 9.181288E−11 | −2.141467E−10 |
| F | −1.451266E−13 | 0 |

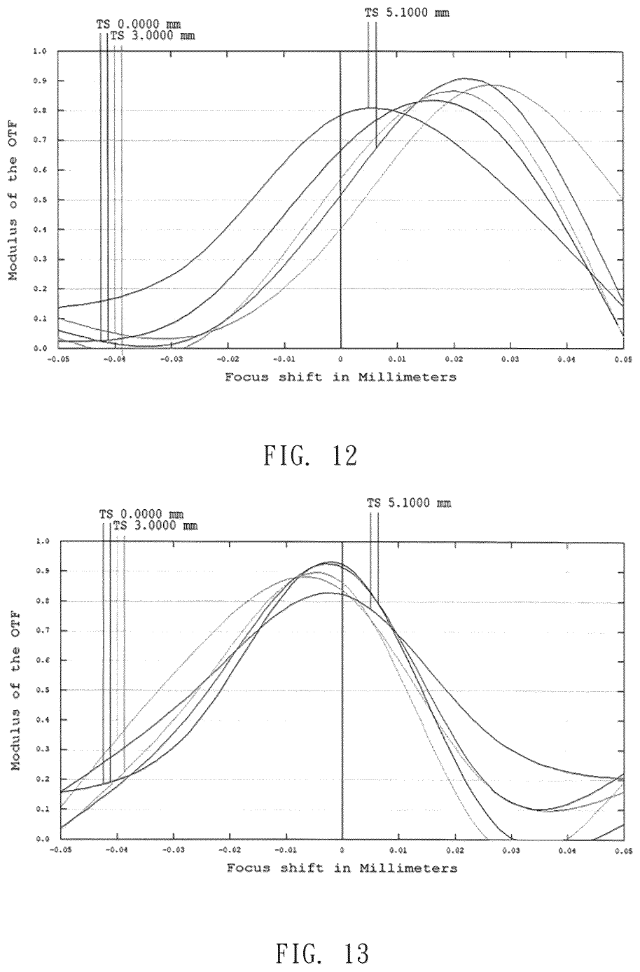

FIG. 12 and FIG. 13 illustrate optical simulation results for the imaging performance of the projection lens 10c. FIG. 12 shows a modulation transfer function (MTF) curve at a short projection distance, and FIG. 13 shows an MTF curve at a long projection distance. A horizontal axis represents focus positions (focus shift in mm), and a vertical axis represents a modulus of an optical transfer function (OTF). Since the curves shown in FIG. 12 and FIG. 13 fall within required ranges, namely that when a spatial frequency is 40 line pairs per millimeter (lp/mm), MTF values within the ranges of the short projection distance and the long projection distance are greater than 40%, this verifies that the projection lens 10c of this embodiment achieves good imaging performance.

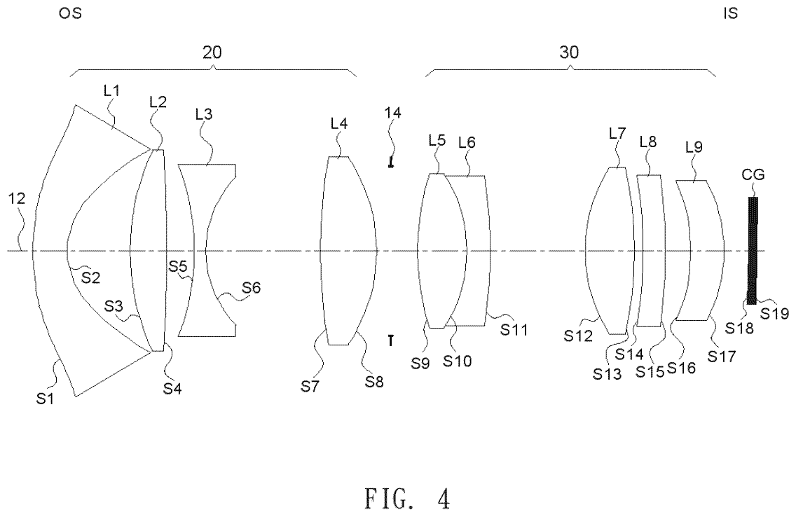

FIG. 4 is a schematic diagram illustrating an optical structure of a projection lens 10d according to a fourth embodiment of the invention. In this embodiment, the projection lens 10d is disposed between a magnified side OS and a minified side IS. The projection lens 10d includes a first lens group 20, an aperture stop 14, and a second lens group 30 arranged in order from the magnified side OS to the minified side IS. In addition, an image source (light-emitting surface) 16 is located at a position corresponding to the minified side IS. In this embodiment, the projection lens 10d consists essentially of nine lenses, and refractive powers of the lenses L1 to L9 are respectively negative, positive, negative, positive, positive, negative, positive, negative, and positive in order along an optical axis 12. The first lens group 20 includes the lenses L1 to L4, and the second lens group 30 includes the lenses L5 to L9. The aspheric lenses L1 and L9 are aspheric glass lenses, and the lenses L2 to L8 are spherical glass lenses. The lens L5 and the lens L6 form a cemented doublet, which can improve chromatic aberration of the projection lens 10d. In one embodiment, the aspheric lens L1 may be an aspheric plastic lens formed of a material such as PMMA or PC. In the fourth embodiment, the effective focal length EFL is 4.837 mm, the back focal length BFL is 2.27 mm, a value of BFL/EFL is 0.4693, a length D of the projection lens is 57.33 mm, a value of BFL/D is 0.0396, and a total track length TTL is 59.60 mm. A ratio of EFL to the short projection distance is 0.008515, and a ratio of EFL to the long projection distance is 0.004499. In this embodiment, a full field of view (FOV) of the projection lens 10d is 97 degrees, an F-number is 1.05, and a ratio of the EFL of the projection lens to an absolute value of an effective focal length of an aspheric lens closest to the magnified side is 0.35. An image height (IMH) of the image source (light-emitting surface) 16 is 5.1 mm. Detailed optical data and design parameters of the lenses and other optical components of the projection lens 10d are shown in Table 7, and conic constants and aspheric coefficients for each aspheric surface are shown in Table 8.

TABLE 7

| | | | Interval | Refractive | Abbe number |
|---|---|---|---|---|---|
| Object description | Surface | Radius(mm) | (mm) | index (Nd) | (Vd) |
| L1(aspheric) | S1* | 53.722 | 2.8845 | 1.80568 | 46.245 |
| | S2* | 9.025 | 5.1773 | | |
| L2(bi-convex) | S3 | 23.502 | 3 | 1.94618 | 18.016 |
| | S4 | −167.84 | 2.2884 | | |
| L3(bi-concave) | S5 | −22.602 | 1 | 1.64647 | 55.408 |
| | S6 | 10.488 | 9.6313 | | |
| L4(bi-convex) | S7 | 67.725 | 4.5892 | 1.71217 | 52.485 |
| | S8 | −15.95 | 1.3687 | | |
| aperture stop | | INF | 1.9028 | | |
| L5(bi-convex) | S9 | 25.192 | 4.122 | 1.72816 | 51.221 |
| L6(meniscus) | S10 | −13.998 | 1.8092 | 1.96659 | 21.124 |
| | S11 | −106.922 | 8.0477 | | |
| L7(bi-convex) | S12 | 15.331 | 3.9574 | 1.78521 | 47.516 |
| | S13 | −53.459 | 0.8731 | | |
| L8(meniscus) | S14 | −44.695 | 1.6778 | 1.94595 | 17.984 |
| | S15 | −102.862 | 2.1277 | | |
| L9(aspheric) | S16* | 396.345 | 2.8725 | 1.84682 | 40.345 |
| | S17* | −30.445 | 1.77 | | |
| cover glass | S18 | INF | 0.5 | 1.523014 | 58.588 |
| light-emitting | S19 | INF | 0 | | |
| surface | | | | | |

TABLE 8

| | S1* | S2* | S16* | S17* |
|---|---|---|---|---|
| R | 53.72 | 9.03 | 396.34 | −30.45 |
| k | 14.00 | −0.26 | −99.00 | 11.43 |
| A | 5.386046E−04 | 7.682537E−04 | −1.083510E−03 | −4.672811E−04 |
| B | −8.686129E−06 | −1.851039E−06 | −3.698380E−06 | −3.060256E−05 |
| C | 8.211097E−08 | −3.653878E−07 | −1.364873E−07 | 2.531246E−06 |
| D | −5.024153E−10 | 8.428742E−09 | 6.098107E−08 | −6.376403E−08 |
| E | 1.760057E−12 | −8.257422E−11 | −2.120971E−09 | 5.338477E−10 |
| F | −2.759165E−15 | 2.860428E−13 | 2.130301E−11 | 0 |

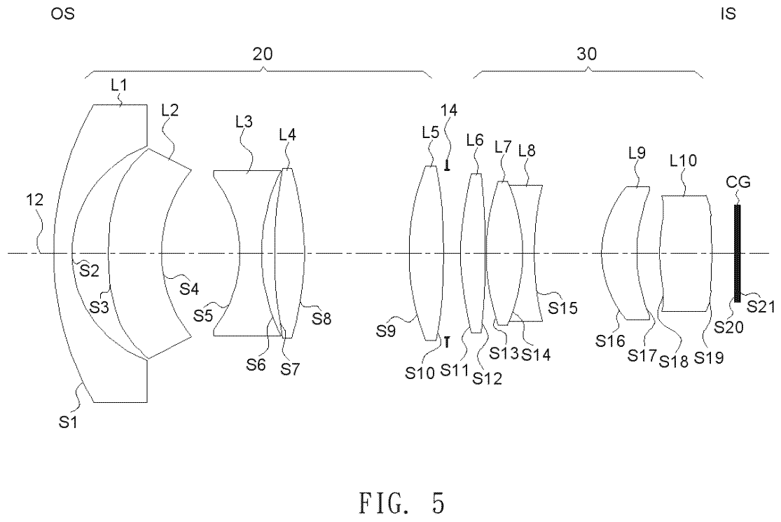

FIG. 5 is a schematic diagram illustrating an optical structure of a projection lens 10e according to a fifth embodiment of the invention. In this embodiment, the projection lens 10e is disposed between a magnified side OS and a minified side IS. The projection lens 10e includes a first lens group 20, an aperture stop 14, and a second lens group 30 arranged in order from the magnified side OS to the minified side IS. In addition, an image source (light-emitting surface) 16 is located at a position corresponding to the minified side IS. In this embodiment, the projection lens 10e consists essentially of ten lenses, and refractive powers of the lenses L1 to L10 are respectively negative, negative, negative, positive, positive, positive, positive, negative, positive, and positive in order along an optical axis 12. The first lens group 20 includes the lenses L1 to L5, and the second lens group 30 includes the lenses L6 to L10. The aspheric lenses L2 and L10 are aspheric glass lenses, and the lenses L1 and L3 to L9 are spherical glass lenses. The lens L7 and the lens L8 form a cemented doublet, which can improve chromatic aberration of the projection lens 10e. In one embodiment, the aspheric lens L2 may be an aspheric plastic lens formed of a material such as PMMA or PC. In the fifth embodiment, the effective focal length EFL is 5.244 mm, the back focal length BFL is 2.3 mm, a value of BFL/EFL is 0.4387, a length D of the projection lens is 62.9 mm, a value of BFL/D is 0.0366, and a total track length TTL is 65.2 mm. A ratio of EFL to the short projection distance is 0.009232, and a ratio of EFL to the long projection distance is 0.004878. In this embodiment, a full field of view (FOV) of the projection lens 10e is 90.92 degrees, an F-number is 1.05, and a ratio of the EFL of the projection lens to an absolute value of an effective focal length of an aspheric lens closest to the magnified side is 0.0991. An image height (IMH) of the image source (light-emitting surface) 16 is 5.1 mm. Detailed optical data and design parameters of the lenses and other optical components of the projection lens 10e are shown in Table 9, and conic constants and aspheric coefficients for each aspheric surface are shown in Table 10.

TABLE 9

| | | | Interval | Refractive | Abbe number |
|---|---|---|---|---|---|
| Object description | Surface | Radius(mm) | (mm) | index (Nd) | (Vd) |
| L1(meniscus) | S1 | 30.811 | 1.6741 | 1.70703 | 52.918 |
| | S2 | 11.244 | 3.494 | | |
| L2(aspheric) | S3* | 67.414 | 5 | 1.6133 | 63.782 |
| | S4* | 21.321 | 7.6289 | | |
| L3(bi-concave) | S5 | −12.326 | 2.0134 | 1.58525 | 38.5 |
| | S6 | 20.333 | 1.2469 | | |
| L4(bi-convex) | S7 | 55.338 | 2.8769 | 2.0051 | 23.528 |
| | S8 | −30.065 | 10.0416 | | |
| L5(bi-convex) | S9 | 26.381 | 3.19 | 1.8578 | 38.971 |
| | S10 | −57.741 | 0.2072 | | |
| aperture stop | | INF | 1.4671 | | |
| L6(bi-convex) | S11 | 31.376 | 2.402 | 1.62985 | 61.524 |
| | S12 | −84.196 | 0.1 | | |
| L7(bi-convex) | S13 | 25.47 | 3.5555 | 1.55712 | 70.389 |
| L8(bi-concave) | S14 | −18.381 | 1 | 1.92571 | 18.33 |
| | S15 | 28.409 | 6.3775 | | |
| L9(meniscus) | S16 | 11.586 | 3.4668 | 1.80291 | 46.569 |
| | S17 | 18.274 | 2.1581 | | |
| L10(aspheric) | S18* | 18.933 | 5 | 1.8042 | 46.503 |
| | S19* | −200 | 1.8 | | |
| cover glass | S20 | INF | 0.5 | 1.523014 | 58.588 |
| light-emitting | S21 | INF | 0 | | |
| surface | | | | | |

TABLE 10

| | S3* | S4* | S18* | S19* |
|---|---|---|---|---|
| R | 67.41 | 21.32 | 18.93 | −200.00 |
| k | 33.41 | −0.65 | −28.79 | 99.00 |
| A | 4.037978E−04 | 5.064715E−04 | 1.345549E−04 | 4.657876E−04 |
| B | −5.622655E−06 | −7.737467E−06 | −2.351241E−05 | −5.756736E−05 |
| C | 8.648945E−08 | 1.145769E−07 | 4.381603E−07 | 1.943055E−06 |
| D | −8.869355E−10 | −9.732787E−10 | −1.533124E−09 | −3.468257E−08 |
| E | 5.470792E−12 | 2.949991E−12 | −9.327467E−11 | 2.538346E−10 |
| F | −1.464715E−14 | −1.683234E−14 | 1.162962E−12 | 0 |

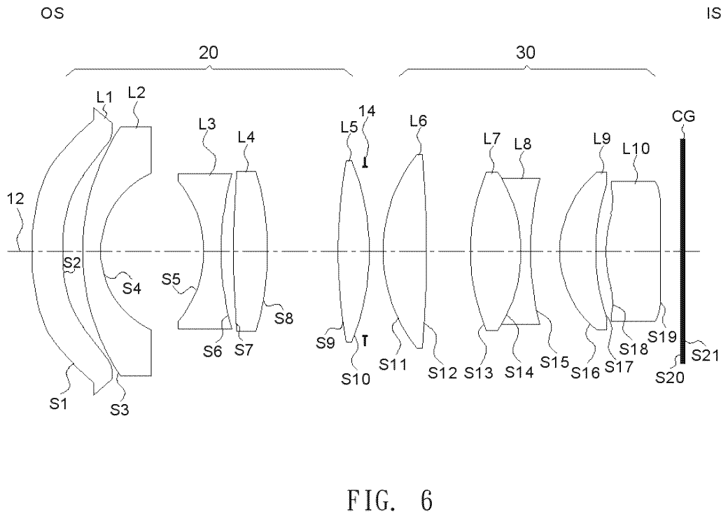

FIG. 6 is a schematic diagram illustrating an optical structure of a projection lens 10f according to a sixth embodiment of the invention. In this embodiment, the projection lens 10f is disposed between a magnified side OS and a minified side IS. The projection lens 10f includes a first lens group 20, an aperture stop 14, and a second lens group 30 arranged in order from the magnified side OS to the minified side IS. In addition, an image source (light-emitting surface) 16 is located at a position corresponding to the minified side IS. In this embodiment, the projection lens 10f consists essentially of ten lenses, and refractive powers of the lenses L1 to L10 are respectively negative, negative, negative, positive, positive, positive, positive, negative, positive, and positive in order along an optical axis 12. The first lens group 20 includes the lenses L1 to L5, and the second lens group 30 includes the lenses L6 to L10. The aspheric lens L1 is an aspheric plastic lens, the aspheric lens L10 is an aspheric glass lens, and the lenses L2 to L9 are spherical glass lenses. The lens L7 and the lens L8 form a cemented doublet, which can improve chromatic aberration of the projection lens 10f. In one embodiment, the aspheric lens L1 may be an aspheric glass lens. In the sixth embodiment, the effective focal length EFL is 4.897 mm, the back focal length BFL is 2.406 mm, a value of BFL/EFL is 0.4913, a length D of the projection lens is 62.599 mm, a value of BFL/D is 0.0384, and a total track length TTL is 65 mm. A ratio of EFL to the short projection distance is 0.00862, and a ratio of EFL to the long projection distance is 0.00456. In this embodiment, a full field of view (FOV) of the projection lens 10f is 94.38 degrees, an F-number is 1.05, and a ratio of the EFL of the projection lens to an absolute value of an effective focal length of an aspheric lens closest to the magnified side is 0.0619. An image height (IMH) of the image source (light-emitting surface) 16 is 5.1 mm. Detailed optical data and design parameters of the lenses and other optical components of the projection lens 10f are shown in Table 11, and conic constants and aspheric coefficients for each aspheric surface are shown in Table 12.

TABLE 11

| | | | Interval | Refractive | Abbe number |
|---|---|---|---|---|---|
| Object description | Surface | Radius(mm) | (mm) | index (Nd) | (Vd) |
| L1(aspheric) | S1* | 100.930 | 2.920 | 1.607921 | 26.9041 |
| | S2* | 32.331 | 2.117 | | |
| L2(meniscus) | S3 | 24.175 | 1.654 | 1.950564 | 25.0113 |
| | S4 | 9.029 | 10.261 | | |
| L3(bi-concave) | S5 | −11.512 | 1.828 | 1.503831 | 77.6311 |
| | S6 | 23.553 | 1.132 | | |
| L4(bi-convex) | S7 | 132.078 | 3.309 | 2.0113 | 22.915 |
| | S8 | −33.550 | 7.292 | | |
| L5(bi-convex) | S9 | 62.193 | 3.056 | 1.500524 | 80.7001 |
| | S10 | −25.191 | −0.739 | | |
| aperture stop | | INF | 2.078 | | |
| L6(bi-convex) | S11 | 16.688 | 4.224 | 1.623046 | 61.6764 |
| | S12 | −150.148 | 4.429 | | |
| L7(bi-convex) | S13 | 20.895 | 5.100 | 1.497645 | 81.4391 |
| L8(bi-concave) | S14 | −15.672 | 1.000 | 1.945945 | 17.9843 |
| | S15 | 26.798 | 2.765 | | |
| L9(meniscus) | S16 | 10.608 | 3.678 | 1.72916 | 54.0952 |
| | S17 | 23.748 | 0.965 | | |
| L10(aspheric) | S18* | 13.483 | 5.529 | 1.7421 | 49.246 |
| | S19* | 120.597 | 1.906 | | |
| cover glass | S20 | INF | 0.5 | 1.523014 | 58.5876 |
| light-emitting | S21 | INF | 0 | | |
| surface | | | | | |

TABLE 12

| | S1* | S2* | S18* | S19* |
|---|---|---|---|---|
| R | 100.9297512 | 32.33137735 | 13.48277532 | 120.5971939 |
| k | 46.96491081 | −0.687585872 | −19.25067915 | 59.62569067 |
| A | 3.92448E−04 | 5.19539E−04 | 5.21798E−04 | 2.31438E−04 |
| B | −4.28986E−06 | −6.51582E−06 | −3.72472E−05 | −3.35625E−05 |
| C | 4.44250E−08 | 8.09064E−08 | 1.01253E−06 | 9.22616E−07 |
| D | −3.03019E−10 | −7.01814E−10 | −2.07267E−08 | −1.25185E−08 |
| E | 1.21092E−12 | 2.88246E−12 | 2.69017E−10 | 6.99671E−11 |
| F | −2.22350E−15 | −4.43502E−15 | −1.50027E−12 | |

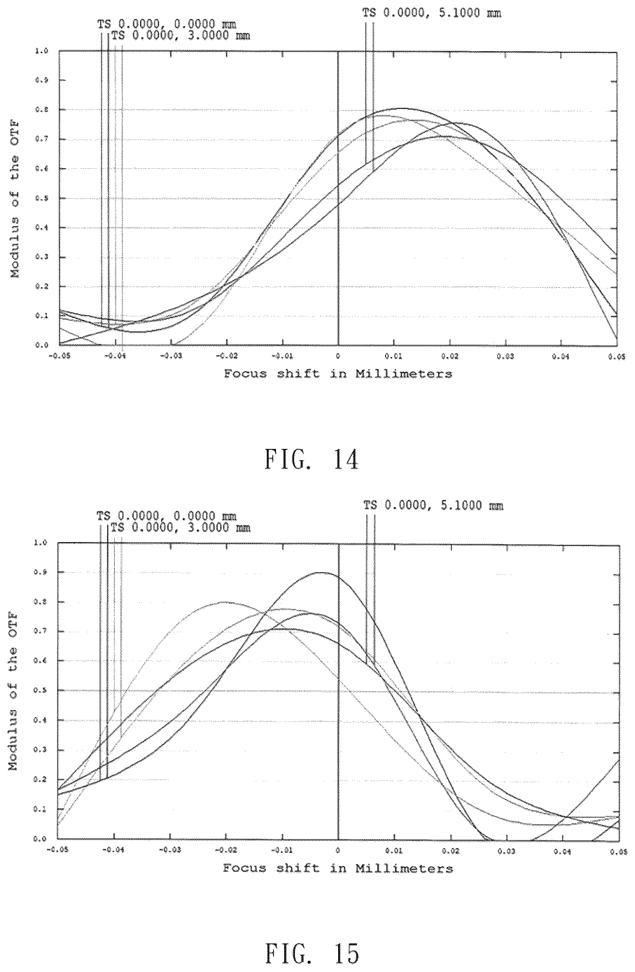

FIG. 14 and FIG. 15 illustrate optical simulation results for the imaging performance of the projection lens 10f. FIG. 14 shows a modulation transfer function (MTF) curve at a short projection distance, and FIG. 15 shows an MTF curve at a long projection distance. A horizontal axis represents focus positions (focus shift in mm), and a vertical axis represents a modulus of an optical transfer function (OTF). Since the curves shown in FIG. 14 and FIG. 15 fall within required ranges, namely that when a spatial frequency is 40 line pairs per millimeter (lp/mm), MTF values within the ranges of the short projection distance and the long projection distance are greater than 40%, this verifies that the projection lens 10f of this embodiment achieves good imaging performance.

In the following embodiments, at a spatial frequency of 40 line pairs per millimeter (lp/mm), when modulation transfer function (MTF) values at two ends of a projection range are 40%, one end corresponds to a short projection distance and the other end corresponds to a long projection distance, and these distances are typically obtained without focus adjustment. A ratio of an effective focal length (EFL) to the short projection distance is in a range between 0.008 and 0.19, a ratio of the EFL to the long projection distance is in a range between 0.002 and 0.005, and a chief ray angle (CRA) of the projection lens is smaller than 8.5 degrees.

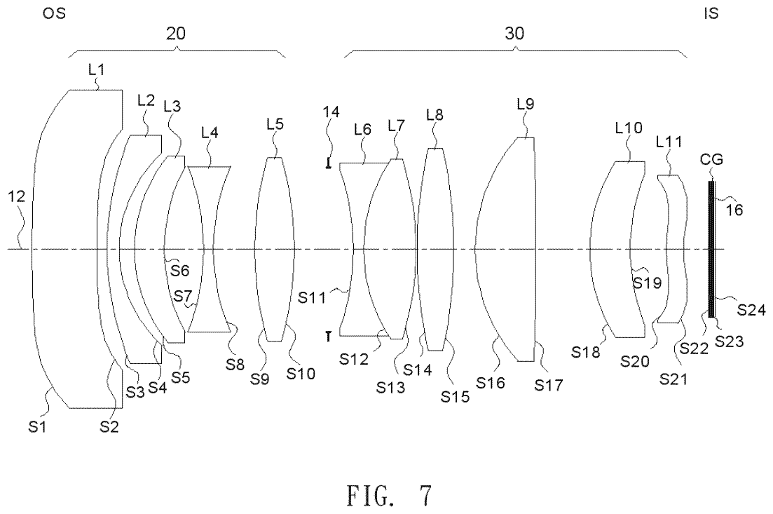

FIG. 7 is a schematic diagram illustrating an optical structure of a projection lens 10g according to a seventh embodiment of the invention. In this embodiment, the projection lens 10g is disposed between a magnified side OS and a minified side IS. The projection lens 10g includes a first lens group 20, an aperture stop 14, and a second lens group 30 arranged in order from the magnified side OS to the minified side IS. In addition, an image source (light-emitting surface) 16 is located at a position corresponding to the minified side IS. In this embodiment, the projection lens 10g consists essentially of eleven lenses, and refractive powers of the lenses L1 to L11 are respectively negative, negative, positive, negative, positive, negative, positive, positive, positive, positive, and positive in order along an optical axis 12. The first lens group 20 includes the lenses L1 to L5, and the second lens group 30 includes the lenses L6 to L11. Specifically, the aspheric lens L1 and the aspheric lens L11 are respectively located at a frontmost end and a rearmost end of the projection lens to correct aberrations and shorten a total track length of the projection lens. The lens L1 is an aspheric plastic lens, and the lens L11 is an aspheric glass lens. The lenses L2 to L5 and the lenses L8 to L10 are spherical glass lenses. The lens L6 and the lens L7 located after the aperture stop 14 form a cemented doublet, wherein the lens L6 is a biconcave lens and the lens L7 is a biconvex lens. This cemented structure can effectively improve chromatic aberration of the projection lens 10g. In one embodiment, the aspheric lens L1 may be an aspheric glass lens. In the seventh embodiment, the effective focal length EFL is 10.9 mm, the back focal length BFL is 3.1 mm, a value of BFL/EFL is 0.2844, a length D of the projection lens is 64.9 mm, a value of BFL/D is 0.0478, and a total track length TTL is 68 mm. A ratio of EFL to the short projection distance is 0.012, and a ratio of EFL to the long projection distance is 0.0022. In this embodiment, a full field of view (FOV) of the projection lens 10g is 61.65 degrees, a chief ray angle (CRA) is 6.2 degrees, an F-number is 1.0, and a ratio of the EFL of the projection lens to an absolute value of an effective focal length of an aspheric lens closest to the magnified side is 0.0286. An image height (IMH) of the image source (light-emitting surface) 16 is 6.6 mm. Detailed optical data and design parameters of the lenses and other optical components of the projection lens 10g are shown in Table 13, and conic constants and aspheric coefficients for each aspheric surface are shown in Table 14.

TABLE 13

| | | | Interval | Refractive | Abbe number |
|---|---|---|---|---|---|
| Object description | Surface | Radius(mm) | (mm) | index (Nd) | (Vd) |
| L1(aspheric) | S1* | −538.1704 | 6.464678 | 1.678 | 54.9 |
| | S2* | 500.000 | 1.049483 | | |
| L2(meniscus) | S3 | 28.89273 | 1.1000 | 1.497 | 81.61 |
| | S4 | 12.60545 | 1.535461 | | |
| L3(meniscus) | S5 | 14.93212 | 2.931499 | 1.946 | 17.94 |
| | S6 | 17.5512 | 3.994458 | | |
| L4(bi-concave) | S7 | −20.85515 | 1.0000 | 1.673 | 32.18 |
| | S8 | 20.85515 | 4.043558 | | |
| L5(bi-convex) | S9 | 32.85258 | 3.961425 | 2.003 | 28.317 |
| | S10 | −32.85258 | 3.458519 | | |
| aperture stop | | INF | 2.422148 | | |
| L6(bi-concave) | S11 | −23.6943 | 1.0000 | 1.785 | 25.72 |
| L7(bi-convex) | S12 | 15.42465 | 5.286437 | 1.618 | 63.41 |
| | S13 | −31.90211 | 0.1200 | | |
| L8(bi-convex) | S14 | 49.87834 | 3.595619 | 1.660 | 57.39 |
| | S15 | −49.87834 | 2.13327 | | |
| L9(bi-convex) | S16 | 16.85556 | 6.060155 | 1.497 | 81.61 |
| | S17 | −372.8506 | 5.370988 | | |
| L10(meniscus) | S18 | 15.44805 | 4.006688 | 1.804 | 46.57 |
| | S19 | 19.32083 | 3.599926 | | |
| L11(aspheric) | S20* | 15.3113 | 1.765687 | 1.806 | 40.73 |
| | S21* | 14.6101 | 2.5000 | | |
| cover glass | S22 | INF | 0.5000 | 1.512 | 62.57 |
| | S23 | INF | 0.1000 | | |
| light-emitting | S24 | INF | 0.0000 | | |
| surface | | | | | |

TABLE 14

| | S1* | S2* | S20* | S21* |
|---|---|---|---|---|
| K | −75.1246 | −99 | −0.76155 | 1.016196 |
| A | 7.26E−05 | 0.000101 | −7.09E−04 | −0.0006 |
| B | −1.19E−07 | −8.13E−08 | −1.41E−05 | −2.76E−05 |
| C | 3.48E−10 | 1.66E−09 | −4.63E−08 | 6.76E−07 |
| D | 8.46E−14 | −1.09E−11 | 6.86E−09 | −6.50E−09 |
| E | −2.15E−15 | 6.01E−14 | −5.88E−11 | 2.28E−11 |
| F | 6.92E−18 | 0 | 0 | 0 |

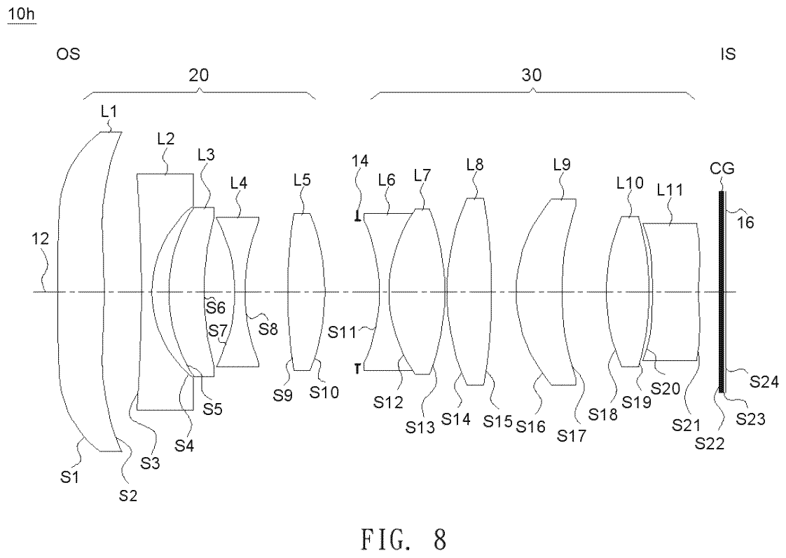

FIG. 8 is a schematic diagram illustrating an optical structure of a projection lens 10h according to an eighth embodiment of the invention. In this embodiment, the projection lens 10h is disposed between a magnified side OS and a minified side IS. The projection lens 10h includes a first lens group 20, an aperture stop 14, and a second lens group 30 arranged in order from the magnified side OS to the minified side IS. In addition, an image source (light-emitting surface) 16 is located at a position corresponding to the minified side IS. In this embodiment, the projection lens 10h consists essentially of eleven lenses, and refractive powers of the lenses L1 to L11 are respectively positive, negative, positive, negative, positive, negative, positive, positive, positive, positive, and negative in order along an optical axis 12. The first lens group 20 includes the lenses L1 to L5, and the second lens group 30 includes the lenses L6 to L11. Specifically, the aspheric lens L1 and the aspheric lens L11 are respectively located at a frontmost end and a rearmost end of the projection lens to correct aberrations and shorten a total track length of the projection lens. The lens L1 is an aspheric plastic lens, and the lens L11 is an aspheric glass lens. The lenses L2 to L5 and the lenses L8 to L10 are spherical glass lenses. The lens L6 and the lens L7 located after the aperture stop 14 form a cemented doublet, wherein the lens L6 is a biconcave lens and the lens L7 is a biconvex lens. This cemented structure can effectively improve chromatic aberration of the projection lens 10h. In one embodiment, the aspheric lens L1 may be an aspheric glass lens. In the eighth embodiment, the effective focal length EFL is 10.62 mm, the back focal length BFL is 3.0 mm, a value of BFL/EFL is 0.282, a length D of the projection lens is 76 mm, a value of BFL/D is 0.0395, and a total track length TTL is 79 mm. A ratio of EFL to the short projection distance is 0.0118, and a ratio of EFL to the long projection distance is 0.00212. In this embodiment, a full field of view (FOV) of the projection lens 10h is 63 degrees, a chief ray angle (CRA) is 1.0 degrees, an F-number is 1.0, and a ratio of the EFL of the projection lens to an absolute value of an effective focal length of an aspheric lens closest to the magnified side is 0.0523. An image height (IMH) of the image source (light-emitting surface) 16 is 6.6 mm. Detailed optical data and design parameters of the lenses and other optical components of the projection lens 10h are shown in Table 15, and conic constants and aspheric coefficients for each aspheric surface are shown in Table 16.

TABLE 15

| | | | Interval | Refractive | Abbe number |
|---|---|---|---|---|---|
| Object description | Surface | Radius(mm) | (mm) | index (Nd) | (Vd) |
| L1(aspheric) | S1* | −99.4305 | 5.470528 | 1.609 | 57.97 |
| | S2* | −56.2314 | 4.40005 | | |
| L2(bi-concave) | S3 | −182.9889 | 1.2 | 1.497 | 81.55 |
| | S4 | 13.07778 | 2.139952 | | |
| L3(meniscus) | S5 | 18.88528 | 4.167257 | 1.973 | 22.24 |
| | S6 | 36.50187 | 3.559581 | | |
| L4(bi-concave) | S7 | −18.7156 | 1.2 | 1.705 | 25.48 |
| | S8 | 22.73153 | 4.945011 | | |
| L5(bi-convex) | S9 | 51.54544 | 4.588909 | 2.001 | 29.13 |
| | S10 | −25.59962 | 4.36565 | | |
| aperture stop | 14 | 1.00E+18 | 2.093383 | | |
| L6(bi-concave) | S11 | −21.09896 | 1.2 | 1.671 | 27.79 |
| L7(bi-convex) | S12 | 17.6073 | 6.567154 | 1.531 | 74.53 |
| | S13 | −26.71888 | 0.2 | | |
| L8(bi-convex) | S14 | 27.5333 | 5.431033 | 1.616 | 63.56 |
| | S15 | −58.75687 | 2.999571 | | |
| L9(meniscus) | S16 | 17.45114 | 5.330265 | 1.511 | 78.47 |
| | S17 | 35.77422 | 5.292409 | | |
| L10(bi-convex) | S18 | 23.75632 | 5.066629 | 1.514 | 77.85 |
| | S19 | −30.53744 | 0.2 | | |
| L11(aspheric) | S20* | 322.4312 | 5.582619 | 1.81 | 41 |
| | S21* | 26.60549 | 2.5 | | |
| cover glass | S22 | 1.00E+18 | 0.5 | 1.512 | 62.57 |
| | S23 | 1.00E+18 | 0 | | |
| light-emitting | S24 | 1.00E+18 | 0 | | |
| surface | | | | | |

TABLE 16

| | S1* | S2* | S20* | S21* |
|---|---|---|---|---|
| K | −50.7073 | −59.9151 | −78.441 | 8.450462 |
| A | 6.89E−05 | 4.41E−05 | −0.00032 | −0.00048 |
| B | −1.96E−07 | 1.03E−08 | −8.57E−07 | −5.97E−07 |
| C | 7.56E−10 | −5.78E−10 | 2.50E−08 | 4.00E−08 |
| D | −2.02E−12 | 2.41E−12 | −6.05E−11 | −4.18E−10 |
| E | 3.69E−15 | −1.35E−15 | 0 | 0 |
| F | −2.67E−18 | −1.37E−17 | 0 | 0 |
| G | | 2.21E−20 | 0 | 0 |

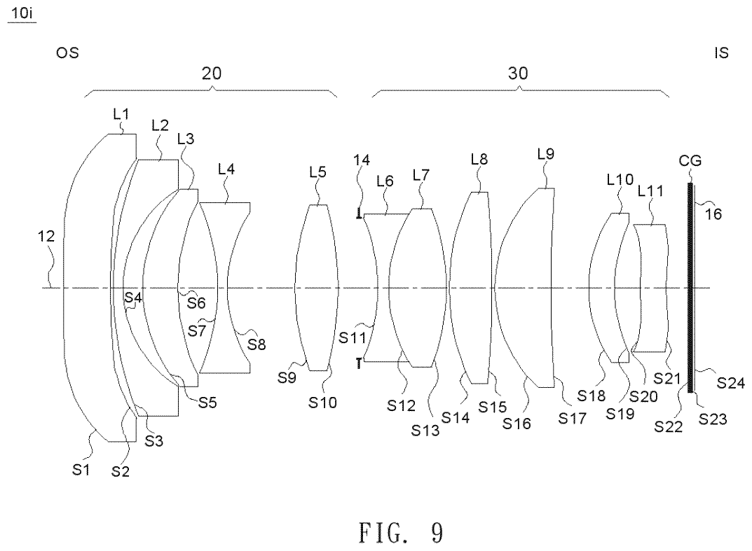

FIG. 9 is a schematic diagram illustrating an optical structure of a projection lens 10i according to a ninth embodiment of the invention. In this embodiment, the projection lens 10i is disposed between a magnified side OS and a minified side IS. The projection lens 10i includes a first lens group 20, an aperture stop 14, and a second lens group 30 arranged in order from the magnified side OS to the minified side IS. In addition, an image source (light-emitting surface) 16 is located at a position corresponding to the minified side IS. In this embodiment, the projection lens 10i consists essentially of eleven lenses, and refractive powers of the lenses L1 to L11 are respectively negative, negative, positive, negative, positive, negative, positive, positive, positive, positive, and negative in order along an optical axis 12. The first lens group 20 includes the lenses L1 to L5, and the second lens group 30 includes the lenses L6 to L11. Specifically, the aspheric lens L1 and the aspheric lens L11 are respectively located at a frontmost end and a rearmost end of the projection lens to correct aberrations and shorten a total track length of the projection lens. The lens L1 is an aspheric plastic lens, and the lens L11 is an aspheric glass lens. The lenses L2 to L5 and the lenses L8 to L10 are spherical glass lenses. It is worth noting that the lens L6 and the lens L7 located after the aperture stop 14 form a cemented doublet, wherein the lens L6 is a biconcave lens and the lens L7 is a biconvex lens. This cemented structure can effectively improve chromatic aberration of the projection lens 10i. In one embodiment, the aspheric lens L1 may be an aspheric glass lens. In the ninth embodiment, the effective focal length EFL is 10.51 mm, the back focal length BFL is 3 mm, a value of BFL/EFL is 0.285, a length D of the projection lens is 69 mm, a value of BFL/D is 0.0435, and a total track length TTL is 72 mm. A ratio of EFL to the short projection distance is 0.0117, and a ratio of EFL to the long projection distance is 0.0021. In this embodiment, a full field of view (FOV) of the projection lens 10i is 63.55 degrees, a chief ray angle (CRA) is 7.2 degrees, an F-number is 1.0, and a ratio of the EFL of the projection lens to an absolute value of an effective focal length of an aspheric lens closest to the magnified side is 0.0006. An image height (IMH) of the image source (light-emitting surface) 16 is 6.6 mm. Detailed optical data and design parameters of the lenses and other optical components of the projection lens 10i are shown in Table 17, and conic constants and aspheric coefficients for each aspheric surface are shown in Table 18.

TABLE 17

| | | | Interval | Refractive | Abbe number |
|---|---|---|---|---|---|
| Object description | Surface | Radius(mm) | (mm) | index (Nd) | (Vd) |
| L1(aspheric) | S1* | −252.6887 | 5.44321 | 1.609 | 57.97 |
| | S2* | −261.3123 | 0.2 | | |
| L2(meniscus) | S3 | 38.21924 | 1.2 | 1.497 | 81.61 |
| | S4 | 13.30527 | 2.190656 | | |
| L3(meniscus) | S5 | 16.77054 | 4.077875 | 2.001 | 25.44 |
| | S6 | 23.16305 | 4.441314 | | |
| L4(bi-concave) | S7 | −24.59469 | 1.2 | 1.581 | 40.75 |
| | S8 | 15.76173 | 7.708022 | | |
| L5(bi-convex) | S9 | 26.6418 | 4.94 | 1.911 | 35.26 |
| | S10 | −36.00557 | 2.750581 | | |
| aperture stop | 14 | 1.00E+18 | 1.823704 | | |
| L6(bi-concave) | S11 | −20.781 | 1.2 | 1.741 | 27.76 |
| L7(bi-convex) | S12 | 16.21706 | 6.722281 | 1.497 | 81.61 |
| | S13 | −23.03747 | 0.2 | | |
| L8(bi-convex) | S14 | 24.6142 | 4.959511 | 1.488 | 70.42 |
| | S15 | −113.8025 | 0.2 | | |
| L9(meniscus) | S16 | 15.64867 | 6.491701 | 1.497 | 81.61 |
| | S17 | 128.2889 | 4.306481 | | |
| L10(meniscus) | S18 | 14.79928 | 3.004479 | 1.804 | 46.57 |
| | S19 | 17.44737 | 2.861386 | | |
| L11(aspheric) | S20* | 25.36723 | 3.08 | 1.81 | 41 |
| | S21* | 22.6718 | 2.5 | | |
| cover glass | S22 | 1.00E+18 | 0.5 | 1.512 | 62.57 |
| | S23 | 1.00E+18 | 0 | | |
| light-emitting | S24 | 1.00E+18 | 0 | | |
| surface | | | | | |

TABLE 18

| | S1* | S2* | S20* | S21* |
|---|---|---|---|---|
| K | −99 | 99 | −2.56357 | 7.125949 |
| A | 8.38E−05 | 0.000101 | −0.00057 | −0.00058 |
| B | −2.39E−07 | −2.86E−07 | −6.11E−06 | −1.03E−05 |
| C | 8.95E−10 | 1.30E−09 | 1.28E−08 | 2.73E−07 |
| D | −2.08E−12 | −5.24E−12 | 2.67E−09 | −2.07E−09 |
| E | 3.26E−15 | 1.87E−14 | −2.13E−11 | −2.96E−13 |
| F | −1.59E−18 | −3.64E−17 | | |

The projection lens according to embodiments of the present disclosure can be applied to a self-luminous light valve (e.g., a Micro LED light source), and a distance between a light-emitting surface of the light source and a lens closest to the light source remains constant. The projection lens according to embodiments of the present disclosure can also be applied to a general conventional light valve (e.g., a DMD, an LCD, or an LCOS), and a distance between the light valve and a lens closest to the light valve remains constant.

The projection lens of the present disclosure has at least one of the following advantages. In embodiments of the invention, the first lens L1 or the second lens L2 is an aspheric glass or plastic lens, other aspheric lenses are aspheric glass lenses, and spherical lenses are spherical glass lenses. This projection lens design without focus adjustment within a certain projection range can provide lower manufacturing costs while maintaining good imaging quality. In addition, by designing with a reduced number of lenses, manufacturing costs and volume are reduced. By the design of embodiments of the invention, at least one of the following specific applications or effects can be provided: for example, no focus adjustment within a certain projection range in vehicles, shock resistance, wide operating temperature range, dust and water resistance, high resolution, large aperture, large field of view, high reliability, or a projection lens design capable of providing lower manufacturing costs and better imaging quality. It should be noted that the projection lens design without focus adjustment within a certain projection range of the invention can also be applied to, for example, warehouse factories, unmanned manufacturing factories, or manufacturing or quality control inspection assembly lines using industrial lenses, and is not limited to vehicle applications.

Though the embodiments of the invention have been presented for purposes of illustration and description, they are not intended to be exhaustive or to limit the invention. Accordingly, many modifications and variations without departing from the spirit of the invention or essential characteristics thereof will be apparent to practitioners skilled in this art. It is intended that the scope of the invention be defined by the claims appended hereto and their equivalents in which all terms are meant in their broadest reasonable sense unless otherwise indicated.

What is claimed is:

1. A projection lens, comprising:
a first lens group, an aperture stop and a second lens group arranged in order from a magnified side to a minified side of the projection lens, the first lens group consisting essentially of four or five lenses, the four or five lenses including an aspheric lens disposed at a position corresponding to a first or second lens as counted from the magnified side toward the minified side, the second lens group consisting essentially of five or six lenses, the five or six lenses including a cemented doublet and an aspheric lens, the aspheric lens of the second lens group being located at a position closest to the minified side,
wherein a total number of aspheric lenses in the projection lens is less than or equal to 3, and the projection lens satisfies the following conditions:
(1) 0.2<BFL/EFL<0.6, where EFL is an effective focal length of the projection lens, and BFL is a back focal length of the projection lens; and
(2) an axial distance between any pair of lenses in the projection lens remains constant during operation.

2. The projection lens as claimed in claim 1, wherein the projection lens satisfies a condition of 0.2<BFL/EFL<0.5, and MTF values at respective two ends of a projection range are each greater than 40% at a spatial frequency of 40 line pairs per millimeter.

3. The projection lens as claimed in claim 1, wherein an F-number of the projection lens is in a range between 0.9 and 1.2, and a chief ray angle of the projection lens is less than 8.5 degrees.

4. The projection lens as claimed in claim 1, wherein the projection lens further comprises an aspheric molded glass lens, and the aspheric molded glass lens is disposed at a position adjacent to the aperture stop.

5. The projection lens as claimed in claim 1, wherein the projection lens includes at most one plastic lens, and a ratio of the EFL of the projection lens to an absolute value of an effective focal length of an aspheric lens closest to the magnified side is in a range between 0 and 0.4.

6. The projection lens as claimed in claim 1, wherein the projection lens can be used with a micro LED light source, and a distance between the micro LED light source and a lens closest to the micro LED light source remains constant.

7. The projection lens as claimed in claim 1, wherein the projection lens satisfies one of the following conditions:
(1) refractive powers are respectively negative, negative, negative, positive, positive, positive, positive, negative, positive, positive in order from the magnified side to the minified side;
(2) refractive powers are respectively negative, negative, positive, negative, positive, negative, positive, negative, positive, positive, positive in order from the magnified side to the minified side;
(3) refractive powers are respectively negative, negative, positive, negative, positive, positive, negative, positive, positive, positive in order from the magnified side to the minified side;
(4) refractive powers are respectively negative, positive, negative, positive, positive, negative, positive, negative, positive in order from the magnified side to the minified side;
(5) refractive powers are respectively negative, negative, positive, negative, positive, negative, positive, positive, positive, positive, positive in order from the magnified side to the minified side;
(6) refractive powers are respectively positive, negative, positive, negative, positive, negative, positive, positive, positive, positive, negative in order from the magnified side to the minified side;
(7) refractive powers are respectively negative, negative, positive, negative, positive, negative, positive, positive, positive, positive, negative in order from the magnified side to the minified side.

8. A projection lens, comprising:
a first lens group, an aperture stop and a second lens group arranged in order from a magnified side to a minified side of the projection lens, the first lens group consisting essentially of four or five lenses, a first lens or a second lens as counted from the magnified side toward the minified side being a molded glass aspheric lens, the second lens group consisting essentially of five or six lenses, the five or six lenses including a cemented doublet and a molded glass aspheric lens disposed at a position closest to the minified side, wherein the projection lens satisfies the following conditions:
(1) 0.02<BFL/D<0.06, where BFL is a back focal length of the projection lens, and D is a distance measured on an optical axis of the projection lens between a lens surface of the projection lens closest to the magnified side and a lens surface of the projection lens closest to the minified side;
(2) an axial distance between any pair of lenses in the projection lens remains constant during operation; and
(3) a total number of aspheric lenses in the projection lens is less than or equal to 3.

9. The projection lens as claimed in claim 8, wherein the projection lens satisfies a condition of 0.02<BFL/D<0.05, and MTF values at respective two ends of a projection range are each greater than 40% at a spatial frequency of 40 line pairs per millimeter.

10. The projection lens as claimed in claim 8, wherein an F-number of the projection lens is in a range between 0.9 and 1.2, and a chief ray angle of the projection lens is less than 8.5 degrees.

11. The projection lens as claimed in claim 8, wherein the projection lens further comprises an aspheric molded glass lens, and the aspheric molded glass lens is disposed at a position adjacent to the aperture stop.

12. The projection lens as claimed in claim 8, wherein the projection lens includes at most one plastic lens, and a ratio of the EFL of the projection lens to an absolute value of an effective focal length of an aspheric lens closest to the magnified side is in a range between 0 and 0.4.

13. The projection lens as claimed in claim 8, wherein the projection lens can be used with a micro LED light source, and a distance between the micro LED light source and a lens closest to the micro LED light source remains constant.

14. The projection lens as claimed in claim 8, wherein the projection lens satisfies one of the following conditions:
(1) refractive powers are respectively negative, negative, negative, positive, positive, positive, positive, negative, positive, positive in order from the magnified side to the minified side;
(2) refractive powers are respectively negative, negative, positive, negative, positive, negative, positive, negative, positive, positive, positive in order from the magnified side to the minified side;
(3) refractive powers are respectively negative, negative, positive, negative, positive, positive, negative, positive, positive, positive in order from the magnified side to the minified side;
(4) refractive powers are respectively negative, positive, negative, positive, positive, negative, positive, negative, positive in order from the magnified side to the minified side;
(5) refractive powers are respectively negative, negative, positive, negative, positive, negative, positive, positive, positive, positive, positive in order from the magnified side to the minified side;
(6) refractive powers are respectively positive, negative, positive, negative, positive, negative, positive, positive, positive, positive, negative in order from the magnified side to the minified side;
(7) refractive powers are respectively negative, negative, positive, negative, positive, negative, positive, positive, positive, positive, negative in order from the magnified side to the minified side.

15. A projection lens, comprising:
a first lens group, an aperture stop and a second lens group arranged in order from a magnified side to a minified side of the projection lens, the first lens group consisting essentially of four or five lenses, and the four or five lenses including a first aspheric lens disposed at a position corresponding to a first or second lens as counted from the magnified side toward the minified side, the second lens group consisting essentially of five or six lenses, the five or six lenses including a cemented doublet and a second aspheric lens, and the second aspheric lens of the second lens group being located at a position closest to the minified side,
wherein a total number of aspheric lenses in the projection lens is less than or equal to 3, and the projection lens satisfies the following conditions:
(1) a depth of field range is defined by EFL/D, where EFL is an effective focal length of the projection lens, and D is a distance measured on an optical axis of the projection lens between a lens surface of the projection lens closest to the magnified side and a lens surface of the projection lens closest to the minified side, and the depth of field range is in a range between 0.075 and 0.19; and
(2) an axial distance between any pair of lenses in the projection lens remains constant during operation.

16. The projection lens as claimed in claim 15, wherein the depth of field range is in a range between 0.075 and 0.095, and MTF values at respective two ends of a projection range are each greater than 40% at a spatial frequency of 40 line pairs per millimeter.

17. The projection lens as claimed in claim 15, wherein an F-number of the projection lens is in a range between 0.9 and 1.2, and a chief ray angle of the projection lens is less than 8.5 degrees.

18. The projection lens as claimed in claim 15, wherein the projection lens further comprises an aspheric molded glass lens, and the aspheric molded glass lens is disposed at a position adjacent to the aperture stop.

19. The projection lens as claimed in claim 15, wherein the projection lens includes at most one plastic lens, and a ratio of the EFL of the projection lens to an absolute value of an effective focal length of an aspheric lens closest to the magnified side is in a range between 0 and 0.4.

20. The projection lens as claimed in claim 15, wherein the projection lens can be used with a micro LED light source, and a distance between the micro LED light source and a lens closest to the micro LED light source remains constant.
